(19) United States
(12) Patent Application Publication
(10) Pub. No.: US 2017/0215421 A1
(43) Pub. Date: Aug. 3, 2017

(54) BIOCIDE AGENTS

(71) Applicant: LANXESS Deutschland GmbH, Cologne (DE)

(72) Inventors: Hermann UHR, Leverkusen (DE); Katrin MOEWS, Dortmund (DE); Monika LAMORATTA, Langenfeld (DE)

(21) Appl. No.: 15/128,678

(22) PCT Filed: Mar. 31, 2015
(86) PCT No.: PCT/EP2015/057128

§ 371 Date: Sep. 23, 2016

(30) Foreign Application Priority Data
Apr. 4, 2014 (EP) 14163600.1

(51) Int. Cl. A01N 43/707; A01N 47/12; A01N 25/28; A01N 47/30

(52) U.S. Cl. CPC A01N 43/707; A01N 47/30; A01N 47/12; A01N 25/28

(57) ABSTRACT

The present invention relates to biocidal agents with excellent fungicidal and algicidal action, consisting at least of an algicide, propiconazole and an iodopropargyl compound, where preferably at least one of the active ingredients is bound, preferably microencapsulated.

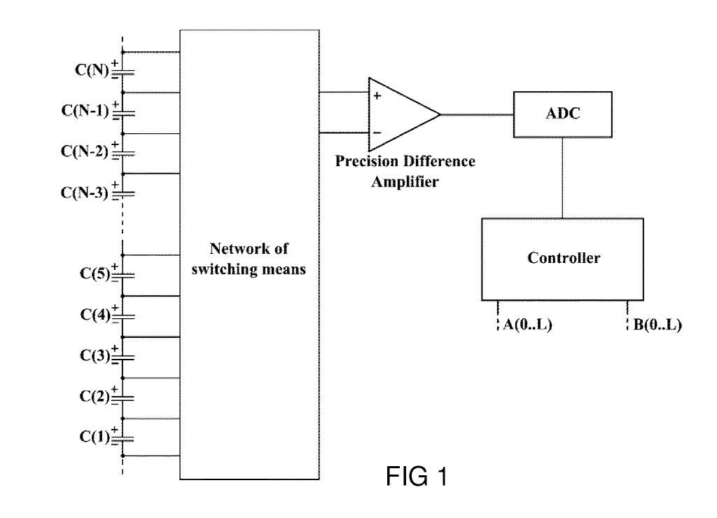

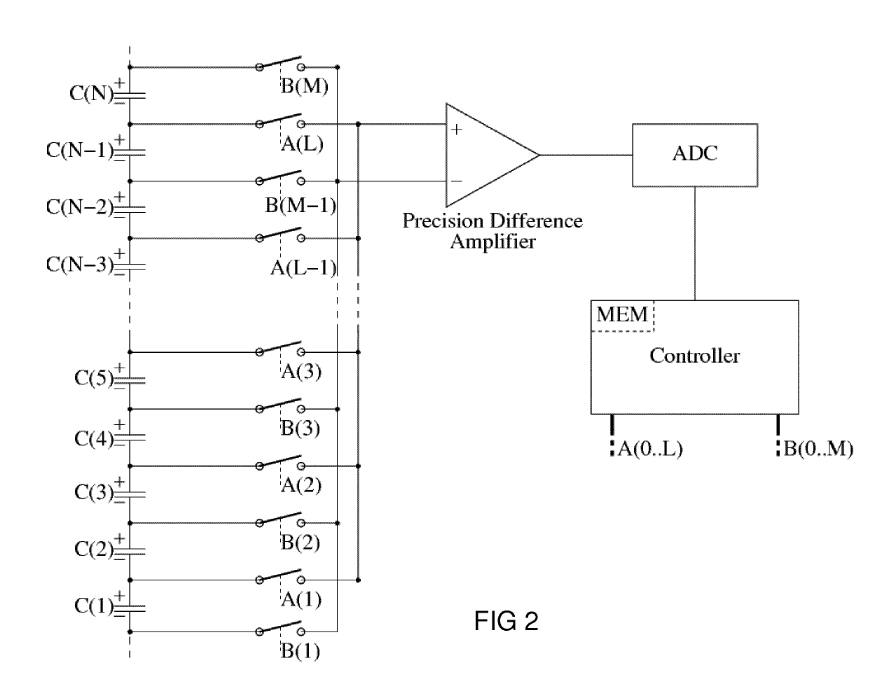

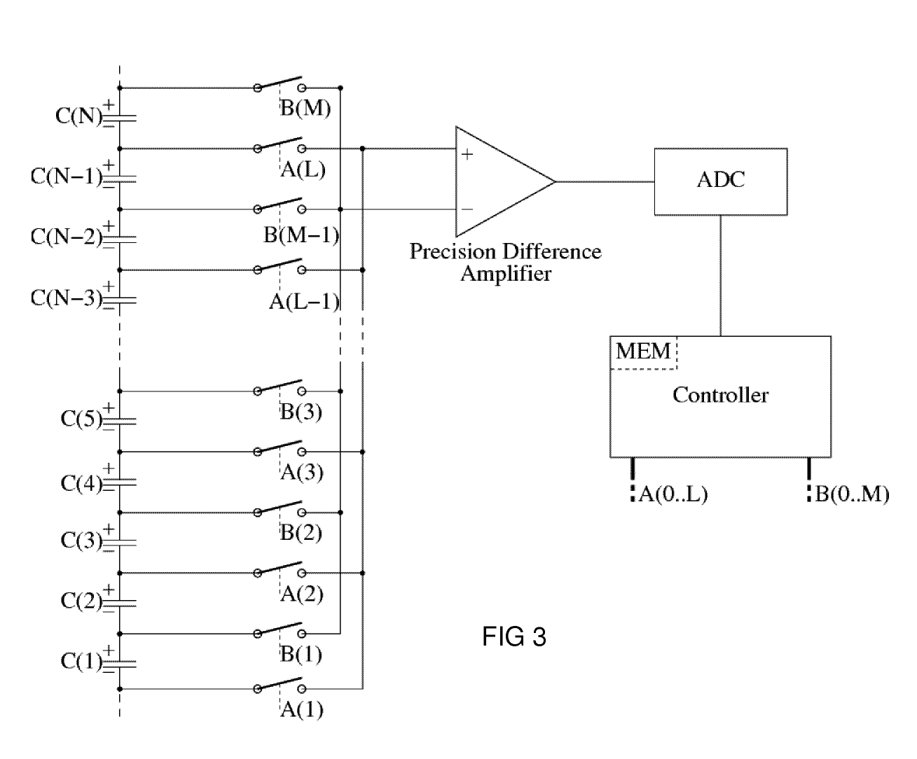

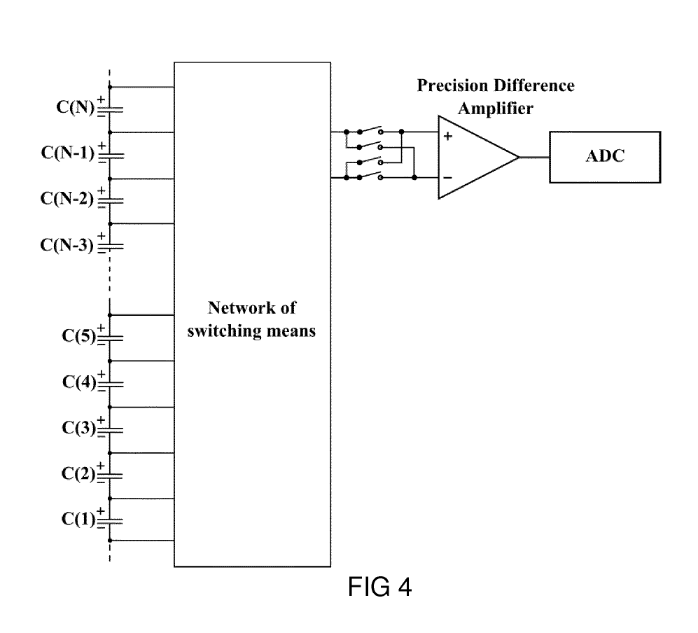

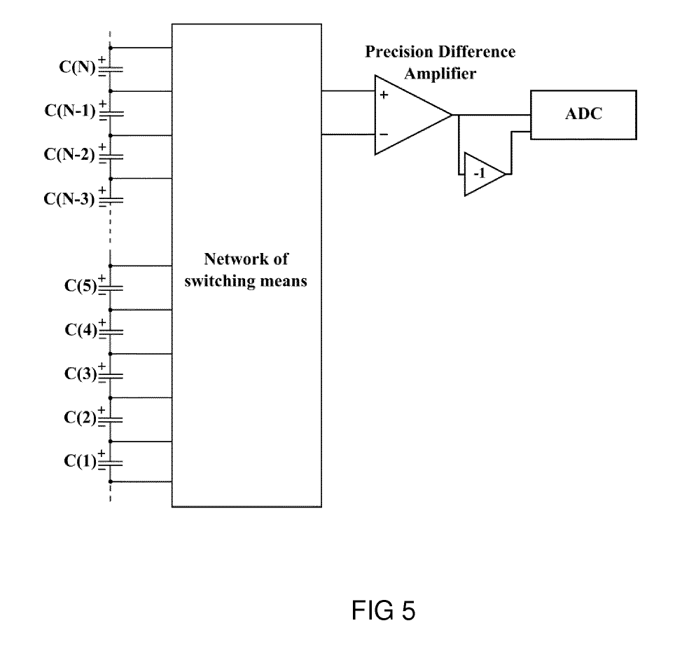

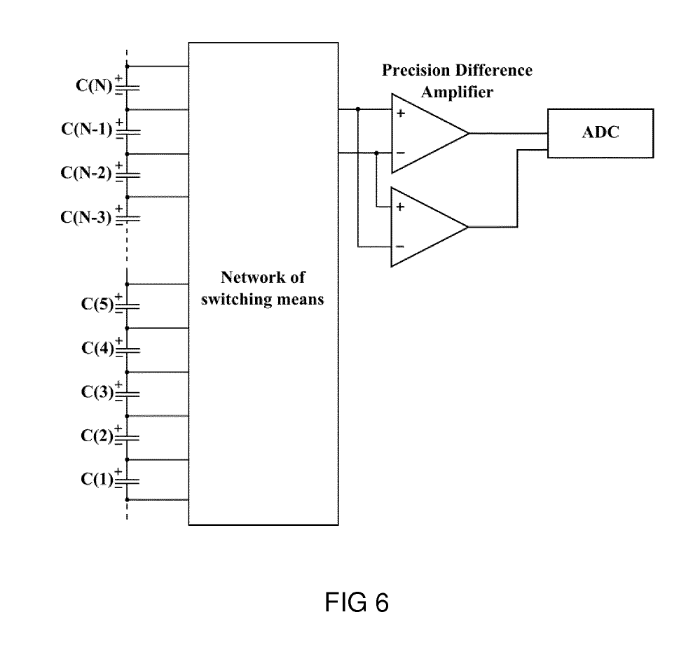

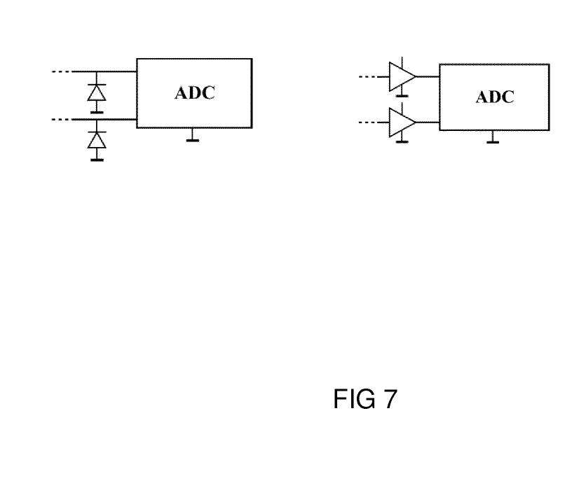

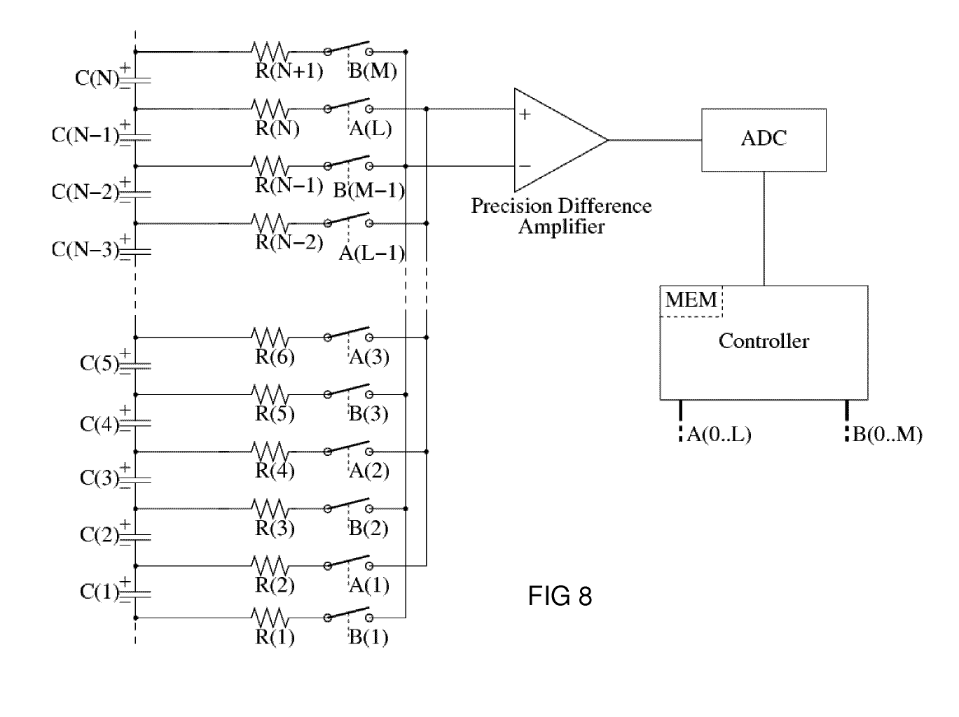

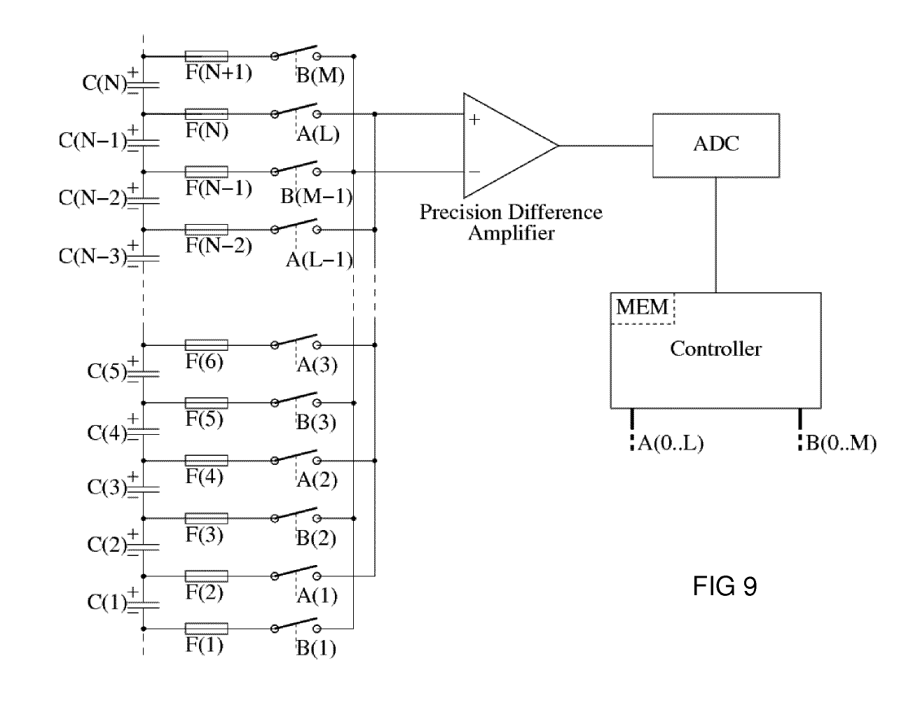

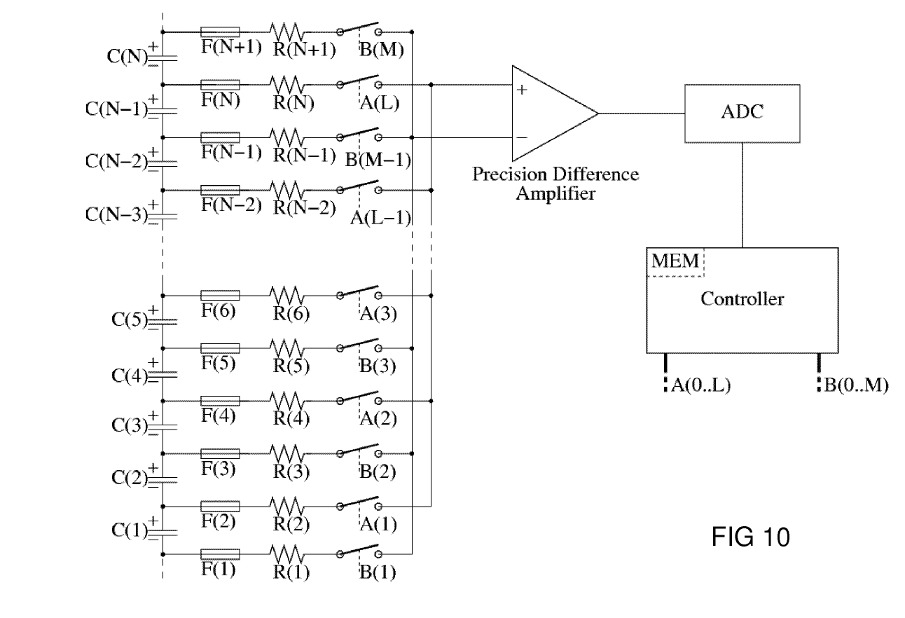

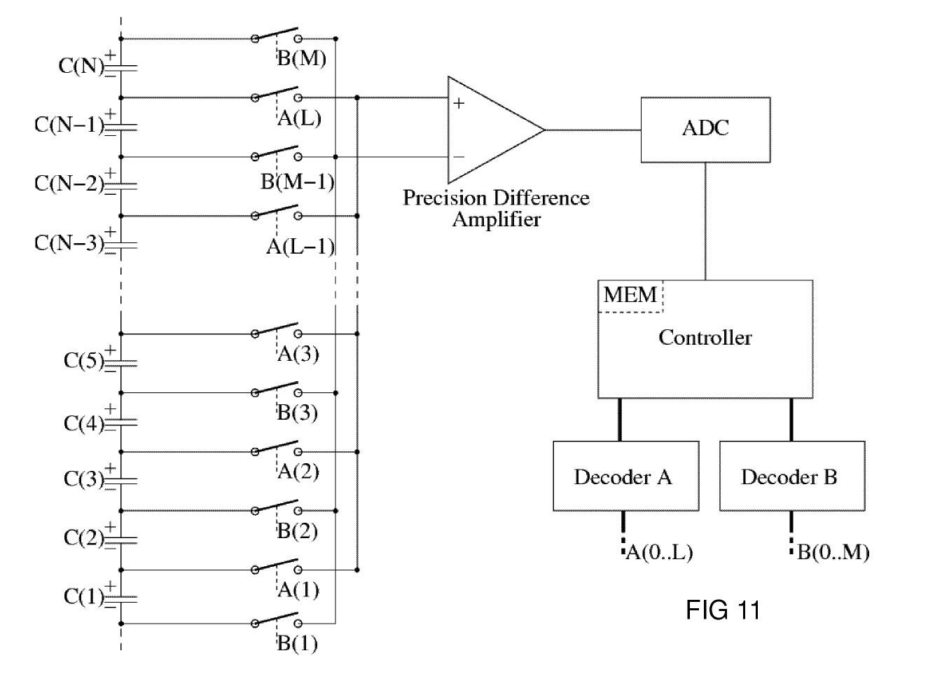

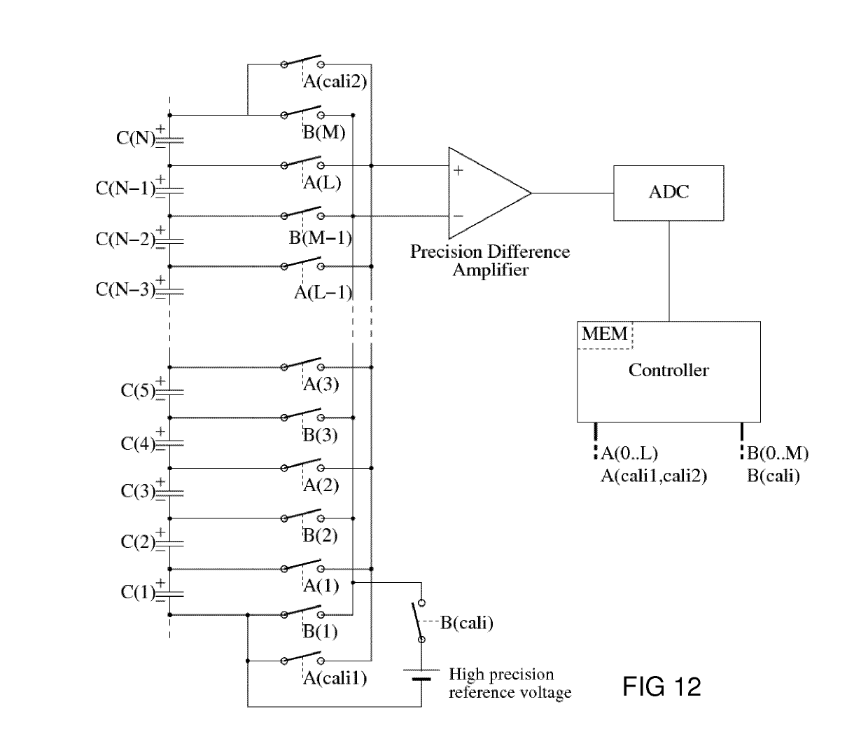

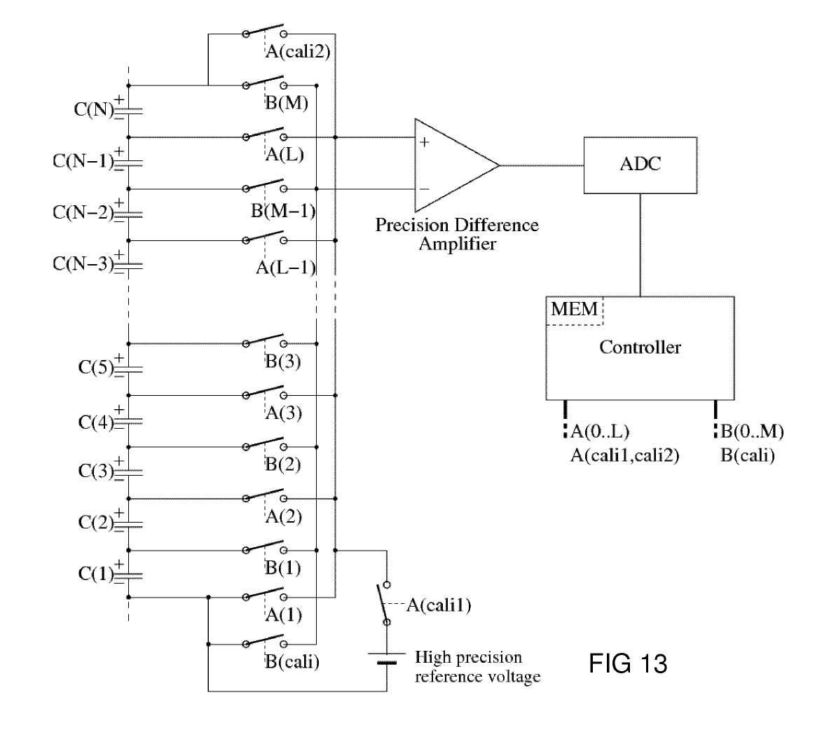

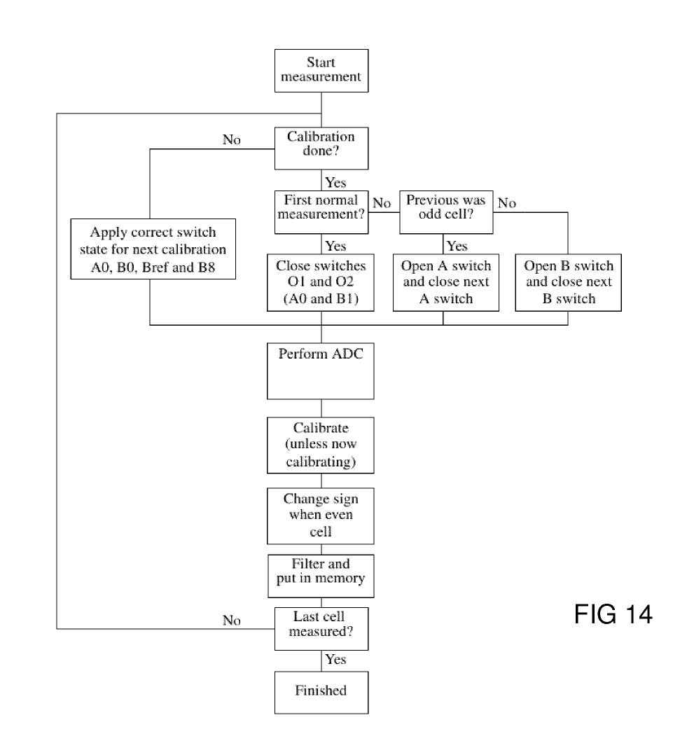

The present invention relates to biocidal agents with excellent fungicidal and algicidal action, consisting at least of an algicide, propiconazole and an iodopropargyl compound, where preferably at least one of the active ingredients is bound, preferably microencapsulated.

Biocidal agents which comprise propiconazole and IPBC are already known from the literature. Such agents are sold for example under the trade name Preventol A 12-TK 20 by Lanxess Deutschland GmbH in the form of an emulsion concentrate with about 10% by weight IPBC and about 10% by weight propiconazole.

Furthermore, JP 2010-126456A discloses active ingredient combinations of algicides and IPBC as wood preservatives.

Furthermore, JP 2011-121901 A discloses wood preservatives which comprise triazole compounds and urea compounds, such as for example propiconazole and diuron.

In many cases, however, the long-term action in the technical materials to be protected such as in particular paints or plasters is not sufficiently good because the biocides are dissolved out of the materials particularly in the exterior sector for example by precipitated water or condensed water. The so-called “leaching” leads to a concentration drop of the biocides, which over time leads to a reduction in the biocidal action to the point of loss of action. In addition to a shortened action time, the precipitated water or condensed water laden with biocides can enter the environment, particularly ground water, and leads to undesired contamination.

For this reason, the general aim is to slow the leaching to such an extent that the released amount of biocides is so low that no unnecessary environmental impact arises, but the amount at the same time suffices to suppress the growth of undesired microorganisms.

The prior an discloses a large number of methods with the help of which the leaching behavior is improved and the release of the biocides is slowed by means of encapsulation, adsorption onto solid supports or inclusion in a polymer matrix.

The active ingredients that are encapsulated, adsorbed to solid supports or bound in a polymer matrix used in contrast to the free active ingredient in the context of a slowed release are also referred to hereinbelow as bound active ingredients.

Among the release mechanisms, a distinction may be made between controlled and triggered release. Triggered release is initiated through changes in the capsule sheath. These changes can be brought about by chemical, biological, magnetic, electronic stimuli or by light.

Controlled release mostly takes place in a diffusion-controlled manner. The literature discloses a large number of systems with diffusion-controlled release. These include polymeric nanoparticles, microspheres, porous silica microparticles, inorganic silica structures, sol-gel matrices and modified nanoclays.

An in often used capsule material is melamine-formaldehyde resins. Thus, for example, it is known from WO 2004/000953 A to incorporate biocides into microcapsules with wall materials made of specific formaldehyde-melanine resins in order to be able to use them in coating materials which have a pH of more than 11.

EP 0 758 633 A describes porous granules which comprise chemical substances, such as e.g. also biocides, and which slowly release them during use.

Furthermore, microcapsules have become known which preferably comprise zinc pyrithione or Irgarol and which are produced by freeing aqueous dispersions of polymer solution, active ingredient and low-boiling solvent from the solvent with vigorous stirring and isolating the resulting microcapsules by filtration (see US 2006/0246144).

Another method of producing “slow release formulations” is coacervation. It is often used for the encapsulation of liquid or solid active ingredients in suspension or emulsion. A distinction is made between simple and complex coacervation. The underlying physical and chemical processes during these two encapsulation methods are well understood and described in detail in the literature. The patent literature describes both the method of complex coacervation (cf. e.g. GB-A 1475229 and U.S. Pat. No. 2,800,458) as well as that of simple coacervation (cf. e.g. GB-A 1275712).

The coacervation of iodopropargyl compounds with e.g. gelatin and gum Arabic is described in EP 1 981 629 A.

A common feature of these methods is that either the solid or dissolved active ingredient is surrounded (encapsulated) with an encapsulation material, the active ingredient is bound to a support by adsorption or solutions of the active ingredient are evaporated with polymers such that the active ingredient is then present as a core surrounded by a polymer wall in the form of fine beads.

A further way of suppressing the leaching of active ingredients is homogeneous distribution of the active ingredient within a polymer matrix. Such biocide-containing, thermoplastic polymer particles to be obtained by extrusion and grinding are described in WO 2009/00650 A.

A mere encapsulation or delayed release, however, is not helpful in every conceivable case since different active ingredients are washed out of paints and plasters at different rates, especially in mixtures.

It was therefore the object to provide a biocidal agent which combines excellent fungicidal and algicidal action with a simultaneously long action time even under weathering conditions.

Biocidal agents have now been found, comprising
A) at least one algicide selected from the group of the triazine algicides, urea algicides and uracil algicides
B) propiconazole
C) at least one iodopropargyl compound,
   where preferably at least one of the active ingredients is bound, preferably microencapsulated.

The term “bound active ingredients” is understood as meaning active ingredients or mixtures of active ingredients which are
encapsulated, preferably microencapsulated and/or
adsorbed to or on solid support materials and/or
encompassed in a polymer matrix.

Bound active ingredients are preferably those which are either encapsulated, preferably microencapsulated, or are bound to or on solid support materials or encompassed in a polymer matrix.

Preferably, at least one of the active ingredients is bound, particularly preferably microencapsulated.

In one embodiment, at least one algicide is bound, preferably microencapsulated.

In one embodiment, the at least one iodopropargyl compound is bound, preferably microencapsulated.

The algicides are selected from the group of the triazine algicides, urea algicides and uracil algicides.

Triazine algicides are for example terbutryn, cybutryn, propazine or terbuton; urea algicides are for example diuron, benzthiazuron, methabenzthiazuron, tebuthiuron, and isoproturon; a uracil algicide is for example terbacil.

The algicides are particularly preferably selected from the group consisting of isoproturon, diuron, cybutryn and terbutryn.

Very particularly preferably, the algicide is diuron.

Iodopropargyl compounds are preferably selected from the group 3-iodo-2-propynyl propylcarbamate, 3-iodo-2-propynyl butylcarbamate (IPBC), 3-iodo-2-propynyl m-chlorophenylcarbamate, 3-iodo-2-propynyl phenylcarbamate, 3-iodo-2-propynyl 2,4,5-trichlorophenyl ether, 3-iodo-2-propynyl-4-chlorophenylformal (IPCF), di(3-iodo-2-propynyl)hexyl dicarbamate, 3-iodo-2-propynyloxyethanol ethylcarbamate, 3-iodo-2-propynyloxyethanol phenylcarbamate, 3-iodo-2-propynyl thioxothioethylcarbamate, 3-iodo-2-propynylcarbamic acid ester (IPC), N-iodopropargyloxycarbonylalanine, N-iodopropargyloxycarbonylalanine ethyl ester, 3-(3-iodopropargyl)benzoxazol-2-one, 3-(3-iodopropargyl)-6-chlorobenzoxazol-2-one, 3-iodo-2-propynyl alcohol, 4-chlorophenyl-3-iodopropargylformal, 3-bromo-2,3-diiodo-2-propenyl ethylcarbamate, 3-iodo-2-propynyl n-hexylcarbamate, 3-iodo-2-propynyl cyclohexylcarbamate.

A particularly preferred iodopropargyl compound is 3-iodo-2-propynyl butylcarbamate (IPBC).

The weight ratio of propiconazole to the sum of iodopropargyl compound(s) can vary with a wide range. In general, the weight ratio of propiconazole to the sum of iodopropargyl compound(s) is 1:100 to 100:1, preferably 1:20 to 20:1 and particularly preferably 1:9 to 9:1.

The weight ratio of algicide(s) to the sum of propiconazole and the sum of iodopropargyl compound(s) can vary within a wide range and is generally 1:100 to 100:1, preferably 1:20 to 20:1 and particularly preferably 1:9 to 9:1.

The biocidal agents according to the invention comprise generally 0.5 to 80% by weight, preferably 1 to 70% by weight, in particular 1 to 60% by weight, of active ingredients based on the sum of the components A), B) and C).

The term encompassed in a polymer matrix means particles, preferably monolithic particles, in which the active ingredient is homogeneously distributed in at least one thermoplastic polymer. “Homogeneously distributed” is also understood as meaning the distribution of an active ingredient introduced after mixing and extrusion into the at least one thermoplastic polymer. Merely by way of clarification, it may be stated that microcapsules which have an active ingredient core that is surrounded by a polymer wall are not encompassed by the term polymer matrix.

Suitable thermoplastic polymers include for example polyacrylates, polyalkylene glycols, in particular polyethylene glycols or polyethylene-polypropylene glycol copolymers (block copolymers or randomly distributed), polyurethanes, polyamides, polyureas, polycarbonates, polyesters or mixtures thereof.

In principle, however, it is also possible to use other thermoplastic polymers not specified here, or mixtures thereof in which the glass transition temperature T_{g} is 30 to 250° C., preferably 50 to 200° C.

In one embodiment 95% of all particles have a particle size of less than 100 μm, preferably from 1 to 50 μm.

The polymer matrix has, for example, an active ingredient content of from 2 to 80% by weight, preferably from 5 to 60% by weight.

Bound active ingredients also include those which are bound to or on solid support materials.

Support materials are, for example and preferably, calcium carbonate, calcium silicates, aluminum silicates, silica gels, kieselguhr, zeolites, sheet silicates, silica gels, fumed or precipitated silicas or modified silicas.

The support materials are very particularly preferably fumed or precipitated silicas.

The binding of active ingredients to or on support materials is known. Either, in the case of liquid active ingredients, the support material is brought into direct contact with the active ingredient or the active ingredients are dissolved in a solvent and vaporized in together with the support material.

Furthermore, the active ingredients can also be introduced into a polymer matrix if the active ingredients are dissolved in monomers and an emulsion polymerisation performed herewith.

The emulsion polymerisation is a method of radical polymerisation of monomers in an aqueous phase. The components necessary for an emulsion polymerisation are water, a water-soluble initiator and the monomers, which have to have a low solubility in water. The result is a polymer dispersion, i.e. a dispersion of the polymer particles formed from the monomer in water. Herein, the active ingredient dissolved simultaneously in the monomer is then preferably homogeneously distributed in the polymer.

Preferably, the emulsion polymers are PVC, polystyrene-, polyacrylate-, polyacrylonitrile- and polyvinyl acetate copolymers.

Further possible encapsulation materials and methods are described in Ullmanns Encyclopedia of Industrial Chemistry 2010 Wiley-VCH GmbH & Co. KGaA, Weinheim, 10.1002/14356007.a16_575.pub2 and the literature cited therein.

Bound active ingredients include and are preferably encapsulated active ingredients, particularly preferably microencapsulated active ingredients.

Encapsulated active ingredients are understood as meaning in particular microencapsulated active ingredients that are completely or partially surrounded by an encapsulation material. They are also referred to below as capsules or microcapsules.

Preferred microcapsules are characterized in that they have, for example, a volume-averaged particle size of from 0.3 to 100 μm. Preferably, the contained microcapsules have a volume-averaged particle size of from 5 to 40 μm. Moreover, the contained microcapsules are characterized in that the D90 value, determined by laser diffraction as volume-weighted distribution, is preferably less than 40 μm.

Preferred microcapsules comprise a melamine-formaldehyde polymer as encapsulation material. The term melamine-formaldehyde polymer is to be understood as meaning a polymer, in which melamine has been polycondensed, typically with formaldehyde in molar excess.

General methods of producing microcapsules, in particular also for producing microcapsules made of melamine-formaldehyde polycondensates are known (see for example C. A. Finch, R. Bodmeier, Microencapsulation, Ullmann's Encyclopedia of Industrial Chemistry, 6th edition 2001, Electronic Release).

The encapsulation material of the contained microcapsules can for example also comprise other synthetic, semisynthetic or natural aminoplast resins. Aminoplast resins are generally understood as meaning polycondensation products of carbonyl compounds with compounds containing NH groups. Of particular interest in this connection are melamine-formaldehyde resins modified with urea or phenol (melamine-urea-formaldehyde-resins, melamine-phenol-formaldehyde resins). Further possible aminoplast resins that can be added to the melamine-formaldehyde resin are for example aminoplast resins of a compound containing NH groups and acetaldehyde or glyoxal. Furthermore, urethane resins, cyanamide resins and dicyanamide resins, aniline resins, sulfonamide resins or mixtures of these resins can be added. These resins and their production are known to the person skilled in the art.

In a further embodiment, as encapsulation material it is also possible to use synthetic materials such as for example acrylic polymers and copolymers, polyacrylamide, polyalkyl cyanoacrylate, and poly(ethylene vinyl acetate), aluminum monostearate, carboxyvinyl polymers, polyamides, poly-(methyl vinyl ether-maleic anhydride), poly(adipyl-L-lysine), polycarbonates, polyterephthalamide, poly(vinyl acetate phthalate), poly(terephthaloyl-L-lysine), polyarylsulfones, poly-(methyl methacrylate), poly(ε-caprolactone), polyvinylpyrrolidone, polydimethylsiloxane, polyoxyethylene, polyester, polyglycolic acid, polylactic acid and copolyers thereof, polyglutamic acid, polylysine, polystyrene, poly(styrene-acrylonitrile), polyimides and polyvinyl alcohol.

In a further embodiment, as encapsulation material it is possible to use semisynthetic materials such as for example cellulose acetate, cellulose acetate butyrate, cellulose acetate phthalate, cellulose nitrate, ethylcellulose, hydroxypropylcellulose, sodium carboxymethylcellulose, hydroxypropylmethylcellulose, methylcellulose, hydroxypropylmethylcellulose phthalate, hydrogenated tallow, myristyl alcohol, glycerol mono- or -dipalmitate, hydrogenated castor oil, glyceryl mono- or -tristearates and 12-hydroxystearyl alcohol.

In a further embodiment, as encapsulation material it is possible to use natural materials such as for example gum Arabic, agar, agarose, maltodextrin, sodium alginate, calcium alginate, dextran, fats, fatty acids, cetyl alcohol, milk solids, molasses, gelatine, gluten, albumin, shellac, starches, caseinates, stearins, sucrose, and waxes, such as beeswax, carnauba wax and spermaceti wax.

The biocidal agents according to the invention can be present in any desired formulation, such as for example in the form of suspension concentrates, water-dispersible powders, water-dispersible granules or simple powder mixtures, where suspension concentrates, powder mixtures and water-dispersible granules are preferred.

In principle, preferred types of formulation are essentially dependent on the intended use and the physical properties required for this. However, since these are known, it is customary practice for the person skilled in the art to ascertain a preferred type of formulation in a few experiments.

The formulations can additionally also comprise further substances, such as stabilizers, pack preservatives and further biocides, such as for example fungicides, algicides, insecticides, acaricides, nematicides, radicides and herbicides or mixtures thereof, preferably fungicides or algicides or mixtures thereof, very particularly preferably algicides.

Besides the combinations according to the invention, the biocidal agents can optionally furthermore comprise various auxiliaries. For the auxiliaries specified below, there is in each case independently of one another also the possibility that they are not present. Possible auxiliaries are for example:
Interface-active substances, such as for example surfactants. Surfactants can be for example nonionic, cationic and amphoteric surfactants, preferably anionic surfactants. Anionic surfactants are for example alkyl sulfates, alkyl ether sulfates, alkylarylsulfonates, alkyl succinates, alkyl sulfosuccinates. N-alkoyl sarcosinates, acyl taurates, acyl isethionates, alkyl phosphates, alkyl ether phosphates, alkyl ether carboxylates, alpha-olefinsulfonates, in particular the alkali metal and alkaline earth metal salts, for example sodium, potassium, magnesium, calcium, and ammonium and triethanolamine salts. The alkyl ether sulfates, alkyl ether phosphates and alkyl ether carboxylates can in each case have for example from 1 to 10 ethylene oxide or propylene oxide units, preferably 1 to 3 ethylene oxide units. Of suitability for example are sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate. The biocidal agents according to the invention can comprise here for example from 0.01 to 10% by weight, preferably from 0.2 to 8% by weight, particularly preferably from 0.3 to 5% by weight and very particularly preferably from 0.5 to 3% by weight of interface-active substances.
Antifoams. The antifoams used are generally interface-active substances which are only weakly soluble in the surface-active solution. Preferred antifoams are those which are derived from natural fats and oils, petroleum derivatives or silicone oils.
Wetting agents, such as for example alkali metal salts, alkaline earth metal salts, ammonium salts of aromatic sulfonic acids, for example ligno-, phenol-, naphthalene- and dibutylnaphthalenesulfonic acid, and of fatty acids, alkyl- and alkylarylsulfonates, alkyl-, lauryl ether and fatty alcohol sulfates, and salts of sulfated hexa-, hepta- and octadecanols or fatty alcohol glycol ethers, condensation products of sulfonated naphthalene and its derivatives with formaldehyde, condensation products of naphthalene and of naphthalenesulfonic acids with phenol and formaldehyde, polyoxyethylene octylphenol ether, ethoxylated isooctyl-, octyl- or nonylphenol, alkylphenol- or tributylphenyl polyglycol ether, tris-sterylphenyl ether ethoxylates, alkylaryl polyether alcohols, isotridecyl alcohol, fatty alcohol ethylene oxide condensates, ethoxylated castor oil, polyoxyethylene alkyl ethers or polyoxypropylene, lauryl alcohol polyglycol ether acetate, sorbitol ester, lignosulfite waste liquors or methylcellulose. The biocidal agents according to the invention can comprise here for example from 0.01 to 8% by weight, preferably from 0.2 to 6% by weight, particularly preferably from 0.3 to 5% by weight and very particularly preferably from 0.5 to 3% by weight of wetting agents.
Emulsifiers, such as for example sodium, potassium and ammonium salts of straight-chain aliphatic carboxylic acids of chain length C₁₀-C₂₀, sodium hydroxyoctadecanesulfonate, sodium, potassium and ammonium salts of hydroxy fatty acids of chain length C₁₀-C₂₀ and their sulfation or acetylation products, alkyl sulfates, as well as triethanolamine salts, alkyl-(C₁₀-C₂₀)-sulfonates, alkyl-(C₁₀-C₂₀)-arylsulfonates, dimethyldialkyl-(C₈-C₁₈)-ammonium chloride, acyl, alkyl, oleyl and alkylaryl oxethylates and their sulfation products, alkali metal salts of sulfosuccinic acid esters with aliphatic saturated monohydric alcohols of chain length C₄-C₁₆, sulfosuccinic acid 4-ester with polyethylene glycol ethers of monohydric aliphatic alcohols of chain length C₁₀-C₁₂ (disodium salt), sulfosuccinic acid 4-ester with polyethylene glycol nonylphenyl ether (disodium salt), sulfosuccinic acid bis-cyclohexyl ester (sodium salt), lignosulfonic acid and the calcium, magnesium, sodium and ammonium salts thereof, polyoxyethylene sorbitan monooleate with 20 ethylene oxide groups, uric acids, hydrogenated and dehydrogenated uric acids, and alkali metal salts thereof, dodecylated diphenyl ether disulfonic acid sodium, and copolymers of ethylene oxide and propylene oxide with a minimum content of 10% by weight of ethylene oxide. The emulsifiers used are preferably: Sodium lauryl sulfate, sodium lauryl ether sulfate, ethoxylated (3 ethylene oxide groups): the polyethylene glykol (4-20)ethers of oleyl alcohol, and the polyethene oxide (4-14)ethers of nonylphenol. The biocidal agents according to the invention can comprise here for example from 0.01 to 15% by weight, preferably from 0.02 to 8% by weight, particularly preferably from 0.05 to 6% by weight and very particularly preferably from 0.1 to 5% by weight of emulsifiers.
Dispersants, such as for example alkylphenol polyglycol ethers. The biocidal agents according to the invention can comprise here for example from 0.01 to 15% by weight, preferably from 0.02 to 8% by weight, particularly preferably from 0.05 to 6% by weight and very particularly preferably from 0.1 to 5% by weight of dispersants.
Stabilizers, such as for example cellulose and cellulose derivatives. The biocidal agents according to the invention can comprise here for example from 0.01 to 6% by weight, preferably from 0.01 to 3% by weight, particularly preferably from 0.01 to 2% by weight and very particularly preferably from 0.01 to 1% by weight of stabilizers.
Stabilizers, such as for example antioxidants, radical scavengers or UV absorbers.
Adhesives or protective colloids, such as for example carboxymethylcellulose, natural and synthetic pulverulent, granular or latex-like polymers, such as gum Arabic, polyvinyl alcohol, polyvinyl acetate, and natural phospholipids, such as cephalins and lecithins and synthetic phospholipid and paraffin oils. The biocidal agents according to the invention can comprise here for example from 0.01 to 8% by weight, preferably from 0.05 to 4% by weight, particularly preferably from 0.2 to 3% by weight and very particularly preferably from 0.2 to 2% by weight of adhesives.
Spreading agents, such as for example isopropyl myristate, polyoxyethylene nonylphenyl ether and polyoxyethylene laurylphenyl ether. The biocidal agents according to the invention can comprise here for example from 0.01 to 20% by weight, preferably from 0.1 to 10% by weight, particularly preferably from 0.1 to 5% by weight and very particularly preferably from 0.1 to 2% by weight of spreading agents.
Fragrances and dyes, such as for example inorganic pigments, for example iron oxide, titanium oxide, Prussian blue and organic dyes such as alizarin, azo and metallophthalocyanine dyes and trace nutrients such as salts of iron, manganese, boron, copper, cobalt, molybdenum and zinc. The biocidal agents according to the invention can comprise here for example in each case from 0.001 to 4% by weight, preferably from 0.01 to 1% by weight, particularly preferably from 0.01 to 0.8% by weight of fragrances and dyes.
Buffer substances, buffer systems or pH regulators. The biocidal agents according to the invention can comprise here for example from 0.01 to 10% by weight, preferably from 0.1 to 5% by weight, of buffer substances, buffer systems or pH regulators.
Thickeners, such as for example polysaccharides, xanthan gum, sodium or magnesium silicates, heteropolysaccharides, alginates, carboxymethylcellulose, gum Arabic or polyacrylic acids, preferably xanthan gum.
Dedusting agents are for example polyglycols and polyglycol ethers. The biocidal agents according to the invention can comprise here for example from 0.01 to 2% by weight, preferably from 0.05 to 3% by weight, particularly preferably from 0.1 to 0.5% by weight of dedusting agents.
As flow agents or release agents it is possible to use for example highly disperse silica or Mg salts of fatty acids. The biocidal agents according to the invention can comprise here, for improving the flowability of the solids, in each case from 0.01 to 5% by weight, preferably from 0.05 to 3% by weight, particularly preferably from 0.1 to 2% by weight of flow agents.
Pack preservatives are for example biocides, bactericides and fungicides. The biocidal agents according to the invention can comprise here for example in each case from 0.01 to 2% by weight, preferably from 0.05 to 1% by weight, of pack preservatives.

The overall content of the aforementioned auxiliaries in the biocidal agents is for example from 0.001 to 20% by weight, preferably from 0.1 to 15% by weight and particularly preferably from 0.1 to 10% by weight.

The biocidal agents can furthermore optionally comprise water and/or organic solvents such as for example oligo- or polyalkylene glycols or triols, or ethers of the aforementioned compounds, in particular with a molecular weight of less than 1000 g/mol.

Very particular preference is given to using water or ethylene glycol, diethylene glycol, triethylene glycol, tetraethylene glycol, polyethylene glycol, propylene glycol, dipropylene glycol, polypropylene glycol, glycerol or mono or di-methyl, ethyl, propyl or butyl ethers of the aforementioned compounds.

Solid formulations, such as for example, powder mixtures or water-dispersible granules (WG) can also comprise solid auxiliaries such as for example natural stone flours, such as kaolins, clay earths, talc, marble, chalk, quartz, attapulgite, montmorillonite or diatomaceous earth or synthetic inorganic substances, such as highly disperse silica, aluminum oxide and silicates, or mixtures thereof.

The solid formulations can be obtained in a manner known per se, for example by intimate mixing of the individual components with the solid auxiliaries or by joint comminution of solid auxiliaries with the individual components. Furthermore, the solid formulations can be obtained by drying, for example spray drying, of a liquid formulation.

The biocidal agents according to the invention can optionally also comprise further active ingredients such as for example fungicides, bactericides, algicides and/or insecticides, either in bound or non-bound form, or be free from further active ingredients such as for example fungicides, bactericides, algicides and/or insecticides.

The optionally additionally present fungicides, bactericides, algicides and/or insecticides that may be present are for example:

triazoles such as azaconazole, azocyclotin, bitertanol, bromuconazole, cyproconazole, diclobutrazole, difenoconazole, diniconazole, epoxyconazole, etaconazole, fenbuconazole, fenchlorazole, fenethanil, fluquinconazole, flusilazole, flutriafol, furconazole, hexaconazole, imibenconazole, ipconazole, isozofos, myclobutanil, metconazole, paclobutrazole, penconazole, prothioconazole, simeoconazole, (±)-cis-1-(4-chlorophenyl)-2-(1H-1,2,4-triazol-1-yl)cycloheptanol, 2-(1-tert-butyl)-1-(2-chlorophenyl)-3-(1,2,4-triazol-1-yl)-propan-2-ol, tebuconazole, tetraconazole, triadimefon, triadimenol, triapenthenol, triflumizole, triticonazole, uniconazole, and their metal salts and acid adducts;
imidazoles such as clotrimazole, bifonazole, climbazole, econazole, fenapamil, imazalil, isoconazole, ketoconazole, lombazole, miconazole, pefurazoate, prochloraz, triflumizole, thiazolcar 1-imidazolyl-1-(4′-chlorophenoxy)-3,3-dimethylbutan-2-one, and metal salts and acid adducts thereof;
pyridines and pyrimidines such as ancymidol, buthiobat, fenarimol, mepanipyrin, nuarimol, pyroxyfur, triamirol;
succinate dehydrogenase inhibitors such as benodanil, carboxim, carboxim sulfoxide, cyclafluramid, fenfuram, flutanil, furcarbanil, furmecyclox, mebenil, mepronil, methfuroxam, metsulfovax, nicobifen, pyrocarbolid, oxycarboxin, shirlan, seedvax:
naphthalene derivatives such as terbinafin, naftifin, butenafin, 3-chloro-7-(2-aza-2,7,7-trimethyl-oct-3-en-5-yne);
sulfenamides such as dichlorfluanid, tolylfluanid, folpet, fluorfolpet; captan, captofol;
benzimidazoles such as carbendazim, benomyl, fuberidazole, thiabendazole or salts thereof;
morpholine derivatives such as aldimorph, dimethomorph, dodemorph, falimorph, fenpropidin, fenpropimorph, tridemorph, trimorphamid and their arylsulfonic acid salts, such as e.g. p-toluenesulfonic acid and p-dodecylphenylsulfonic acid;
benzothiazoles such as: 2-mercaptobenzothiazole;
benzthiophene dioxides such as: benzo[b]thiophene S,S-dioxide-carboxylic acid cyclohexylamide;
benzamides such as: 2,6-dichloro-N-(4-trifluoromethylbenzyl)benzamide, tecloftalam;
boron compounds such as: boric acid, boric acid esters, borax;
formaldehyde and formaldehyde-eliminating compounds such as benzyl alcohol mono-(poly)hemiformal, 1,3-bis(hydroxymethyl)-5,5-dimethylimidazolidine-2,4-diones (DMDMH), bisoxazolidines, n-butanol hemiformal, cis-1-(3-chloroallyl)-3,5,7-triaza-1-azoniandamantane chloride, 1-[1,3-bis(hydroxymethyl-2,5-dioxoimidazolidin-4-yl]-1,3-bis(hydroxymethyl)urea, dazomet, dimethylolurea, 4,4-dimethyloxazolidines, ethylene glycol hemiformal, 7-ethylbicyclooxazolidines, hexahydro-S-triazines, hexamethylenetetramine. N-hydroxymethyl-N′-methylthiourea, methylenebismorpholine, sodium N-(hydroxymethyl)glycinate. N-methylolchloroacetamide, oxazolidines, paraformaldehyde, tauroline, tetrahydro-1,3-oxazine, N-(2-hydroxypropyl)amine methanol, tetrtmethylolacetylenediurea (TMAD);
isothiazolinones such as N-methylisothiazolin-3-one, 5-chloro-N-methylisothiazolin-3-one, 4,5-trimethyleneisothiazolinone, 4,5-benzisothiazolinone, N-methylbenzisothiazolinone, N-butylbenzisothiazolinone;
aldehydes such as cinnamaldehyde, formaldehyde, glutardialdehyde, β-bromocinnamaidehyde, o-phthaldialdehyde;
thiocyanates such as: thiocyanatomethylthiobenzothiazole, methylene bisthiocyanate;
quaternary ammonium compounds and guanidines such as benzalkonium chloride, benzyldimethyltetradecylammonium chloride, benzyldimethyldodecylammonium chloride, dichlorobenzyldimethylalkylammonium chloride, didecyldimethylammonium chloride, dioctyldimethylammonium chloride, N-hexadecyltrimethylammonium chloride, 1-hexadecylpyridinium chloride, iminoctadine tris(albesilate);
iodine derivatives such as diiodomethyl-p-tolylsulfone, 3-iodo-2-propynyl alcohol, 4-chlorophenyl-3-iodopropargylformal, 3-bromo-2,3-diiodo-2-propenyl ethylcarbamate, 2,3,3-triiodoallyl alcohol, 3-bromo-2,3-diiodo-2-propenyl alcohol, 3-iodo-2-propynyl n-hexylcarbamate, 3-iodo-2-propynyl cyclohexylcarbamate, 3-iodo-2-propynyl phenylcarbamate;
phenols such as tribromophenol, tetrachlorophenol, 3-methyl-4-chlorophenol, 3,5-dimethyl-4-chlorophenol, dichlorophene, 2-benzyl-4-chlorophenol, triclosan, diclosan, hexachlorophene, p-hydroxybenzoic acid methyl ester, p-hydroxybenzoic acid ethyl ester, p-hydroxybenzoic acid propyl ester, p-hydroxybenzoic acid butyl ester, p-hydroxybenzoic acid octyl ester, o-phenylphenol, m-phenylphenol, p-phenylphenol, 4-(2-tert-butyl-4-methylphenoxy)phenol, 4-(2-isopropyl-4-methylphenoxy)phenol, 4-(2,4-dimethylphenoxy)phenol and alkali metal and alkaline earth metal salts thereof;
microbicides with activated halogen group such as Bronidox, 2-bromo-2-nitro-1,3-propanediol, 2-bromo-4′-hydroxyacetophenone, 1-bromo-3-chloro-4,4,5,5-tetramethyl-2-imidazoldinone, β-bromo-β-nitrostyrene, chloroacetamide, chloramine T, 1,3-dibromo-4,4,5-tetramethyl-2-imidazoldinones, dichloramine T, 3,4-dichloro-(3H)-1,2-dithiol-3-one, 2,2-dibromo-3-nitrilepropionamide, 1,2-dibromo-2,4-dicyanobutane, halane, halazone, mucochloric acid, phenyl(2-chlorocyanovinyl)sulfone, phenyl(1,2-dichlorom-2-cyanovinyl)sulfone, trichloroisocyanuric acid;
pyridines such as I-hydroxy-2-pyridinethione (and its Cu, Na, Fe, Mn, Zn salts), tetrachloro-4-methylsulfonylpyridine, pyrimethanol, mepanipyrim, dipyrithione, 1-hydroxy-4-methyl-6-(2,4,4-trimethylpentyl)-2(1H)-pyridine;
methoxyacrylates or similar such as azoxystrobin, dimoxystrobin, fluoxastrobin, kresoxim-methyl, metominostrobin, orysastrobin, picoxystrobin, pyraclostrobin, trifloxystmrobin, 2,4-dihydro-5-methoxy-2-methyl-4-[2-[[[[1-[3-(trifluoromethyl)phenyl]ethylidene]amino]oxy]methyl]phenyl]-3H-1,2,4-triazol-3-one (CAS-No. 185336-79-2);
metal soaps such as salts of the metals tin, copper and zinc with higher fatty, resin, naphthenic acids and phosphoric acid such as e.g. tin, copper, zinc naphthenate, octoote, 2-ethylhexanoate, oleate, phosphate, benzoate;
metal salts such as salts of the metals tin, copper, zinc, and also chromates and dichromates such as e.g. copper hydroxycarbonate, sodium dichromate, potassium dichromate, potassium chromate, copper sulfate, copper chloride, copper borate, zinc fluorosilicate, copper fluorosilicate;
oxides such as: oxides of the metals tin, copper and zinc such as e.g. tributyltin oxide, Cu2O, CuO, ZnO;
oxidizing agents such as hydrogen peroxide, peracetic acid, potassium persulfate;
dithiocarbamates such as cufraneb, ferban, potassium N-hydroxymethyl-N′-methyldithiocarbamate, Na or K dimethyldithiocarbamate, macozeb, maneb, metam, metiram, thiram, zineb, ziram;
nitriles such as 2,4,5,6-tetrachloroisophthalodinitrile, disodium cyanodithioimidocarbamate;
quinolines such as: 8-hydroxyquinoline and Cu salts thereof;
other fungicides and bacterncides such as bethoxazin, 5-hydroxy-2(5H)-furanone; 4,5-benzdithiazolinone, 4,5-hrimethylenedithiazolinone, N-(2-p-chlorobcnzoylethyl)hexaminium chloride, 2-oxo-2-(4-hydroxyphenyl)acethydroximoyl chloride, tris-N-(cyclohexyldiazeniumdioxy)aluminum, N-(cyclohexyldiazeniumdioxy)tributyltin and K salts, bis-N-cyclohexyldiazeniumdioxy)copper, iprovalicarb, penflufen, solatenol, fenhexamid, spiroxamin, carpropamid, diflumnetorin, quinoxyfen, famoxadone, polyoxorim, acibenzolar-S-methyl, furametpyr, thifluzamide, methalaxyl-M, benthiavalicarb, metrafenon, cyflufenamid, tiadinil, tea tree oil, phenoxyethanol,
Ag, Zn or Cu-containing zeolites alone or incorporated into polymeric materials.

Very particularly preferably, the fungicides and bactericides are:

azaconazole, bromuconazole, cyproconazole, dichlobutrazole, diniconazole, hexaconazole, metaconazole, penconazole, propiconazole, tebuconazole, dichlofluanid, tolylfluanid, tiadimnefon, fluorfolpet, methfuroxam, carboxin, benzo[b]thiophene S,S-dioxide-carboxylic acid cyclohexylamide, fenpiclonil, 4-(2,2-difluoro-1,3-benzodioxol-4-yl) 1H-pyrrole-3-carbonitrile, butenafin, imazalil, N-methylisothiazolin-3-one, 5-chloro-N-methylisothiazolin-3-one, penflufen, solatenol, dichloro-N-octylisozhiazolinone, mercapbobenzthiazole, thiocyanatomethylthiobenzothiazole, thiabendazole, benzisodhiazolinone, N-(2-hydroxypropyl)aminomethanol, benzyl alkohol (hemi)formal, N-methylolchloroacetamide, N-(2-hydroxypropyl)amine-methanol, glutaraldehyde, omadine, Zn omadine, dimethyl dicarbonate, 2-bromo-2-nitro-1,3-propanediol, bethoxazine, o-phthaldialdehyde, 2,2-dibromo-3-nitrilepropionamide, 1,2-dibromo-2,4-dicyanobutane, 1,3-bis(hydroxymethyl)-5,5-dimethylimidazolidine-2,4-diones (DMDMH), tetramethylolacetylenediurea (TMAD), ethylene glycol hemniformal, p-hydroxybenzoic acid, carbendazim, chlorophene, 3-methyl-4-chlorophenol, o-phenylphenol.

The algicides are preferably:

acetochlor, acifluorfen, aclonifen, acrolein, alachlor, alloxydim, ametryn, amidosulfuron, amitrole, ammonium sulfamate, anilofos, asulam, atrazine, azafenidin, aziptrotryn, azimsulfuron,
benazolin, benfluralin, benfuresat, bensulfuron, bensulfid, bentazon, benzofencap, benzthiazuron, bifenox, bispyribac, bispyribac-sodium, borax, bromacil, bromobutide, bromofenoxim, bromoxynil, butachlor, butamifos, butralin, butylate, bialaphos, benzoyl-prop, bromobutide, butroxydim,
carbetamid, carfentrazone-ethyl, carfenstrol, chlomethoxyfen, chloramnben, chlorbromuron, chlorflurenol, chloridazon, chlorimuron, chlornitrofen, chloroacetic acid, chloransulam-methyl, cinidon-ethyl, chlorotoluron, chloroxuron, chlorpropham, chlorsulfuron, chlorthal, chlorthiamid, cinmethylin, cinofulsuron, clefoxydim, clethodlim, clomzone, chlomeprop, clopyralid, cyaniamide, cyanazine, cycloate, cycloxydim, chloroxynil, clodinafop-propargyl, cumyluron, clometoxyfen, cyhalofop, cyhalofop-butyl, clopyrasuluron, cyclosulfamuron,
diclosulam, dichlorprop, dichlorprop-P, diclofop, diethatyl, difenoxuron, difenzoquat, diflufenican, diflufenzopyr, dimefuron, dimepiperate, dimethachlor, dimethipin, dinitramine, dinoseb, dinoseb acetate, dinoterb, diphenamid, dipropetryn, diquat, dithiopyr, diduron, DNOC, DSMA, 2,4-D, daimuron, dalapon, dazomet, 2,4-DB, desmedipham, desmetryn, dicamba, dichlobenil, dimethamnid, dithiopyr, dimethametryn,
eglinazin, endothal, EPTC, esprocarb, ethalfluralin, ethidimuron, ethofumesat, ethobenzanid, ethoxyfen, ethametsulfuron, ethoxysulfuron,
fenoxaprop, fenoxaprop-P, fenuron, flamprop, flamprop-M, flazasulfuron, fluazifop, fluazifop-P, fuenachlor, fluchloralin, flufenacet flumeturon, fluorocglycofen, fluoronitrofen, flupropanate, flurenol, fluridone, flurochloridone, fluroxypyr, fomsafen, fosamine, fosameuine, flamprop-isopropyl, flamprop-isopropyl-L, flufenpyr, flumiclorac-pentyl, flumipropyn, flumioxzim, flurtamon, flumioxzim, flupyrsulfuron-methyl, fluthiacet-methyl.
glyphosates, glufosinate-ammonium
haloxyfop, hexazinone,
imazamethabenz, isoproturon, isoxaben, isoxapyrifop, imazapyr, imazaquin, imazethapyr, ioxynil, isopropalin, imazosulfurwn, imazomox, isoxaflutole, imazapic,
ketospiradox,
lactofen, lenacil, linuron,
MCPA, MCPA hydrazide, MCPA-thioethyl, MCPB, mecoprop, mecoprop-P, mefenacet, mefluidid, mesosulfuron, metam, metamifop, metamitron, metazachlor, methabenzthiazuron, methazole, methoroptryne, miethyldymron, methyl isothiocyanate, metobromuron, metoxuron, metribuzin, metsulfuron, molinate, monalid, monolinuron, MSMA, metolachlor, metosulamn, metobenzuron,
naproanilide, napropamide, naptalam, neburon, nicosulfuron, norflurazone, sodium chlorate,
oxadizone, oxyfluorfen, oxysulfuron, orbencarb, oryzalin, oxadiargyl,
propyzamide, prosulfocarb, pyrazolates, pyrazolsulfuron, pyrazoxyfen, pyribenzoxim, pyributicarb, pyridat, paraquat, pebulat, pendimethalin, pentachlorophenol, pentoxazon, pentanochlor, petroleum oils, phenmedipham, picloram, piperophos, pretilachlor, primisulfuron, prodiamine, profoxydim, prometryn, propachlor, propanil, propaquizafob, propazine, propham, propisochlor, pyriminobac-methyl, pelargonic acid, pyrithiobac, pyraflufen-ethyl,
quinmerac, quinocloamine, quizalofop, quizalofop-P, quinchlorac,
rimsulfuron
sethoxydim, sifuron, simazine, simetryn, sulfosulfuron, sulfometuron, sulfentrazone, sulcotrione, sulfosate,
tar oils, TCA, TCA-sodium, tebutam, tebuthiuron, terbacil, terbumeton, terbutylazine, terbutryn, thiazafluoron, thifensulfuron, thiobencarb, thiocarbazil, tralkoxydim, triallate, triasulfuron, tribenuron, triclopyr, tridiphane, trietazine, trifluralin, tycor, thdiazimin, thiazopyr, triflusulfuron,
vernolate.

In a preferred embodiment, the liquid agents according to the invention comprise no further fungicides, bactericides, algicides and/or insecticides.

The invention furthermore relates to the use of the biocidal agents according to the invention for protecting technical materials. Suitable technical materials are in particular adhesives, sizes, paper, cardboard, leather, wood, woodbase materials, wood/plastic composites, paints, coating compositions, plasters, cooling lubricants and heat transfer liquids. Very particular preference is given to paints, coating substances, plasters, wood and woodbase materials.

The invention moreover relates to a method of protecting technical materials against attack and/or destruction by microorganisms, characterized in that the biocidal agents according to the invention are allowed to act, neat or diluted with water, on the microorganism or its habitat.

The invention moreover relates to technical materials obtainable by treating technical materials with the biocidal agents according to the invention.

In the case of paints and coating compositions, both the still-liquid, as well as the dried system are protected against attack by microorganisms, particularly fungi and algae.

Microorganisms which can bring about a degradation or a change in technical materials are for example bacteria, fungi, yeasts, algae and mucosa organisms. Preferably, the agents according to the invention are used to combat fungi, in particular mold fungi, wood-staining and wood-destroying fungi (Basidiomycetes), as well as to combat algae.

Algae are preferably prokaryotic algae (Cyanophyta, blue algae) such as for example representatives from the subclass Coccogoneae and the subclass Hormogoneae.

By way of example, mention may be made from the order Chroococcales of species of the genera Synechococcus, Chroococcus, Glococapsa, Aphanocapsa, Aphanothece, Microcystis and Merismopedia; from the orders Chamaesiphonales and Pleurocapsales of species of the genera Chamaesiphon and Dermatocarpa; from the order Oscillatoriales of the species of the genera Phormidium, Schizothrix, Spirulina, Plectonema and Lyngbya; from the order Nostocales of species of the genera Nostoc, Rivularia, Tolypothrix, Scytonema, Anabaenopsis, Calothrix and Aulosira; from the order Stigonematales of the species of the genera Stigonema, Fischerella, Hapalosiphon and Mastigocladus.

Further, the agents also exhibit good efficacy towards eukaryotic representatives from the divisions Heterokontophya, Rhodophyta, Chlorophyta, Euglenophyta, Cryptophyta, Dinophyta and Haptophyta.

By way of example, mention may be made from the class Xanthophyceae of species of the genera Tribonema and Vaucheria; from the class Chrysophyceae of species of the genera Chrysocapsa, Rhizochrysis, Cfhrysosphaera, Phaeothamnion and Thallochrysis; from the class Phaeophyceae (brown algae) of species of the genera Ectocarpus, Pylaiella, Cutleria, Zanardinia, Dictyota, Padina, Dictyopteris, Laminaria, Macrocystis, Lessonia, Nerocystis, Chorda, Alaria, Fucus, Ascophyllum, Himanthalia, Sargassum, Cystoseira, Halidrys, Pelvetia, Coccophora and Durvilla; from the class Rhodophyceae (red algae) of species of the genera Porphyridum, Bangia, Porphyra, Corallina, Lithothamnia, Lithophyllum, Rhodymania, Delesseria, Grinnellia, Platysiphonia. Polysiphonia, Ceramium, Plumaria, from the class Chlorophyceae (green algae) of species of the genera Chlorococcum, Chlorella, Spongiochloris, Monostroma, Ulva, Enteromorpha, Ulothrix, Trentepohlia, Apatococcus, Desmococcus, Cladophora, Siphonocladus, Valonia, Caulerpa, Bryopsis, Acetabularia, Halimeda and Tuna.

Fungi which may be mentioned are for example microorganisms of the following genera:

Alternaria, such as for example Alternaria tenuis, Aspergillus, such as for example Aspergillus niger, Chaetomium, such as for example Chaetomium globosum, Coniophora, such as for example Coniophora puetana, Lentinus, such as for example Lentinus tigrinus, Penicillium, such as for example Penicillium glaucum, Polyporus, such as for example Polyporus versicolor, Aureobasidium, such as for example Aureobasidium pullulans, Sclerophoma, such as for example Sclerophoma pityophila, Trichoderma, such as for example Trichoderma viride.

The application rate of the agents according to the invention is governed by the nature and occurrence of the microorganisms to be controlled and by the composition of the material to be protected. The optimum use amount can be ascertained simply and in a manner sufficiently known to the person skilled in the art by test series. In general, the biocidal agent according to the invention is used such that the overall concentration of the active ingredients according to components A), B) and C) in the material to be protected is from 20 to 10,000 ppm by weight, preferably 50 to 5000 ppm by weight.

The advantage of the invention is regarded as being that the biocidal agents according to the invention exhibit a superior, because it is reduced, leaching behavior coupled with simultaneously high efficacy and action time.

The examples which follow illustrate the present invention.

### EXAMPLES

### Materials

Gum Arabic solution (4% by weight)

Coadis™ BR3 (50% by weight in H2O) (dispersion reagent; aqueous polyacrylate salt solution from Coatex)

SILOFOAM®SRE (silicone antifoam emulsion antifoam from Wacker)

Maprenal®/water solution (1:1) (Maprenal® MF 921 w/85WA melamine-formaldehyde binder from INEOS Melamines)

Preventol® D7 (pack preservative with about 1.5% by weight chloromethylisothiazolinone/methylisothiazolinone 3:1)

Preventol® BIT 20D (pack preservative with about 20% by weight benzisothiazolinone)

Urea

Preventol® A 6 (Diuron)

Preventol® MP 100 (IPBC)

Preventol® A 12 (Propiconazole)

Sipernat® 50 S (precipitated silica; Evonik)

Preventol® A 14-D (suspension comprising 20% Diuron, 10% BCM, 3% OIT)

Preventol® MP 400 (suspension comprising 40% IPBC; manufacturer Lanxess)

Soprophor® S25 (emulsifier based on tris-sterylphenyl ether ethoxylates)

Preventol® BM 25 (pack preservative comprising 2.4% by weight benzisothiazolinone and 4.9% by weight methylisothiazolinone)

Rhodopol-G® (thickener based on xanthan gum from Solvay Rhodia)

Pluronic F127: Ethylene oxide-propylene oxide block copolymer

Oparyl MT 820: Sodium didisobutylnaphthalenesulfonate

### Example 1 (Production of Propiconazole on Sipernat 50 S)

463 g of propiconazole (content 97.1% by weight) were charged to a pot and heated to 60° C. With paddle-blade stirring, 300 g of Sipernat 50 S were slowly added thereto. The initially doughy mass became readily stirrable and free-flowing after a short time. Finally, 3.75 g of Aerosil 200 were also added and the mixture was stirred further.

This gave a white, free-flowing powder. To monitor the homogeneity, samples were taken at three different points and analyzed as to the active ingredient content using HPLC:

In this connection, contents of 58.7% by weight, 58.7% by weight and 59.5% by weight of propiconazole were ascertained.

### Example 2 (Production of Encapsulated Diuron)

A 1000 ml stainless steel beaker was charged at room temperature with 33.79 g of gum Arabic solution, 6.75 g of Coadis® BR3 solution and 451.5 g of water together with 2.7 g of defoamer Silfoam® SRE. By adding citric acid solution (50% by weight), the pH was adjusted to 2.99. Then, 135 g of diuron were added with stirring and the mixture was thoroughly mixed for 30 minutes using a stirring rod (Ultra-Turrax). The crude mixture was transferred to a 1000 ml flat-flange pot and heated to the deposition temperature of 60° C. At this temperature, 135.5 g of a Maprenal®/water solution (1:1) were added dropwise to the diuron suspension over a period of 3 hours. When the addition was complete, the mixture was heated to 80° C. and stirred for 4 hours. Then, the mixture was cooled to room temperature and further stirred for 12 hours. The pH was then adjusted to pH 8 by adding sodium hydroxide solution (50% by weight). Then, the 2.26 g of Soprophor® S25, 0.75 g of Preventol® D7, 0.72 g of Preventol® BIT 20D, 1.2 g of Rhodopol-G® and 37.65 g of urea were added and the mixture was stirred to homogeneity. Content: 16.5% by weight of diuron.

### Example 3 (Production of Encapsulated IPBC)

In a 1 L stainless steel pot, at room temperature, 3.76 g of Coadis BR, 37.5 g of 4% strength by weight gum Arabic solution and 3.03 g of antifoam Wacker SRE were processed in 637.22 g of water with stirring to give a slightly cloudy solution.

Then, by adding 8.85 g of a 50% strength by weight solution of citric acid in water, the pH was reduced from pH=7.70 to pH=2.96.

The solution obtained in this way was transferred to a 1000 ml flat-flange pot with impeller stirrer and Ultraturrax. With stirring using an impeller stirrer, 150.09 g of IPBC were added at approx. 400-420 rpm.

Then, the mixture was heated to 70° C., during which above 60° C. and from the onset of melting of the IPBC, the Ultra-Turrax was switched on (15600 rpm) and, after reaching 70° C., the mixture was emulsified for at least 30 min.

Then, 150 g of a 50% strength by weight solution of Marprenal MF 921w/85WA in water was metered in over the course of 3 h. The Ultra-Turrax initially continued to run. After 10% of the melamine-formaldehyde polymer had been metered in, the Ultra-Turrax was switched off and the reaction mixture was stirred further only by means of impeller stirrer at an unchanged stirring speed.

Following the complete metered addition of the melamine-formaldehyde polymer, the reaction mixture was after-stirred for a further 4 h at 70° C., then let down and removed by suction with membrane pump vacuum. The moist filtercake was then washed with 67 g, 27 g and 7 g of hot (80° C.) water. This gave 312.50 g of the white, moist product.

### Example 4

At room temperature, 75.57 g of Preventol MP 400, 30 g and 104 g of water were stirred. To this was added, with stirring, 25 g of propiconazole on Sipernat 50 S (see Example 1) and stirring was continued for 30 minutes until the suspension was homogeneous. Then, 269.46 g of the capsule suspension from Example 2 were added and the mixture was homogenized with slow stirring. To this was added, with further stirring, 0.5 g of Preventol D 7, 0.5 g of Preventol BIT 20 D, 20.0 g of a 3% strength aqueous solution of Rhodopol G in water (xanthan gum solution) and a further 6 g of water. The homogeneous white suspension comprised 9.0% by weight of diuron, 6.1% by weight of IPBC and 3.0% by weight of propiconazole. The viscosity (rotary viscometer RC 20/Rheotec) was 370.3 mPas at 30 l/s.

### Example 5

### Propiconazole Emulsion

At RT, 61.66 g of propiconazole and 21.43 g of methyl oleate were mixed together with stirring. To this were added 10 g of Soprophor S 25, 1.5 g of Pluronic F 127 and 2.5 g of Oparyl MT 820 and the mixture was stirred for 30 minutes. Then, 322.3 g of water were added and the mixture was emulsified on the dissolver (10000 rpm). Finally, a further 0.5 g of Preventol D 7. 0.5 g of Preventol BIT 20 D, 39.8 g of a 3% strength solution of Rhodopol G in water and a further 39.8 g of water were added with stirring. The white emulsion comprised 12.7% by weight of propiconazole (HPLC).

Preparation of the Suspoemulsion

At room temperature, 90 g of Preventol MP 400-D and 26.2 g of water are stirred with 150 g of the propiconazole emulsion according to this example. Then, with further stirring, 327.27 g of the capsule suspension according to Example 2, 0.6 g of Preventol D 7, 0.6 g of Preventol BIT 20 D, 2.83 g of 3% strength aqueous solution of Rhodopol G and 3.67 g of further water were added.

This gave a white suspoemulsion with the following active ingredient contents (HPLC):

8.9% by weight of diuron
6.0% by weight of IPBC
3.2% by weight of IPBC
Viscosity: 237 mPas at 30 l/s.

### Example 6

10 g of Pluronic F 127 and 10 g of Soprophor S 25 were firstly dissolved in 95.6 g of water and then, with stirring, 62.76 g of the encapsulated IPBC from Example 3 were added. With further stirring, a further 272.73 g of the encapsulated diuron from Example 2 were added and the mixture was after-stirred for 30 min. Then, a further 1.0 g of Preventol BM 25, 15.05 g of 3% strength Rhodopol G solution and a further 8.35 g of water were added with stirring.

This gave a white, homogeneous suspension with a viscosity of 541 mPas at 30 I/s (rotary viscometer/Rheotec). Active ingredient contents (HPLC):

8.9% by weight of diuron
6.3% by weight of IPBC
3.0% by weight of propiconazole.

### Example 7: Investigation of the Fungicidal and Algicidal Efficacy

To assess the fungicidal and algicidal efficacy, two exterior emulsion paints were equipped with the biocidal agents according to Example 4, a homogeneous white suspension comprising 9.0% by weight of diuron, 6.1% by weight of IPBC and 3.0% by weight of propiconazole in the stated amounts.

The exterior emulsion paints used were:

### Paint No. 1:

| | | |
|---|---|---|
| Tronox Titanium RKB2 | 35.0 | Titanium dioxide |
| EWO powder | 20.0 | BaSO₄ |
| Micro Mica | 15.0 | Magnesium aluminum silicate |
| Talc AT1 | 5.0 | Magnesium silicate |
| Chalk BLP2 | 25.0 | Calcite (CaCO₃) |
| Tylose MH 2000 P2, 2% | 20.0 | Methylhydroxyethylcellulose |
| H₂O | 5.0 | Distilled water |
| Calgon N, 10% | 2.5 | Polyphosphate |
| Pigment distributor A, 10% | 2.5 | Polyacrylic acid salt |
| Mowilith DM 2H (binder) | 80.0 | Polyvinyl acetate |
| Sum | 210.0 | |
| Solids fraction | 140.0 | 66.7% |

### Paint No. 2:

| | | |
|---|---|---|
| Tronox Titanium RKB2 | 40.0 | Titanium dioxide |
| Talco 1N | 15.0 | Magnesium silicate |
| Durcal 5 | 45.0 | Calcite (CaCO₃) |
| Walsroder MC 3000 S 2% | 30.0 | Methylcellulose |
| H2O | 6.5 | Distilled water |
| Calgon N 10% | 3.0 | Polyphosphate |
| Pigment distributor A 10% | 1.0 | Polyacrylic acid salt |
| Agitan 281 (1:1 in Texanol) | 1.0 | Antifoam |
| White spirit | 5.0 | Mixture of aliphatic hydro- |
| | | carbons |
| Butyl diglycol acetate | 1.5 | |
| Acronal 290 D (binder) | 71.0 | Polyacrylic acid ester |
| Sum | 219.0 | |
| Solids fraction | 135.5 | 61.9% |

To simulate aging, the samples, after drying, were soaked for 24 h in running tap water at a flow rate of 6 Uh (+/−1 L) (24 h washing). One set of the unsoaked samples was subjected to UV irradiation for 4 weeks and visually assessed after 1, 2 and 4 weeks. All samples were subjected to an agar diffusion test (AD test). The following test organisms were used: Ascomycetes and Deuteromycetes (Alternaria alternata, Aspergillus flavus, Aspergillus niger, Aspergillus ustus, Aureobasidium pulhdans, Cladosporium herbaru, Paecilomyces variotii, Paecilomyces variotii, Penicillium citrinum and Stachybotrys chartarum) and Algae (known facade destroyers: Phiormidiumn tergestinum, Chlorella vulgaris, Phormidium spec., Desmodesmus commuis).

Evaluation of the AD Test

The evaluation of the mold test takes place after incubation for 3 weeks at 29° C.+/−1° C.

Passed: [Good/Moderate]

)* Inhibition of algae growth
0 (0- . . . ) Surface of the specimen growth-free, but zone of inhibition around the specimen [in mm]
0 Surface of the specimen growth-free
1)# Corner growth, marginal growth on the specimen
1 Surface of the specimen covered with up to 10% growth
2 Surface of the specimen covered with 10-30% growth

Not Passed: [Inadequate]

3 Surface of the specimen covered with 30-50% growth
4 Surface of the specimen covered with 50-100% growth

TABLE 1
Results of the AD test against mold and algae in exterior emulsion
paint based on PVAc (Paint No. 1)

| | Mold | | Algae | |
|---|---|---|---|---|
| Finish [% by weight] | OB | 24 h washing | OB | 24 h washing |
| Unpreserved (0.00) | 4 | 4 | 4 | 4 |
| 0.50 | 1 | 3 | 0)* | 0)* |
| 0.75 | 1^{#} | 2 | 0)* | 0)* |
| 1.00 | 0 (0-20) | 1 | 0)* | 0)* |
| 1.25 | 0 (0-20) | 1 | 0)* | 0)* |
| 1.50 | 0 (0-20) | 1^{#} | 0)* | 0)* |
| 1.75 | 0)* | 1^{#} | 0)* | 0)* |
| 2.00 | 0)* | 0 (0-20) | 0)* | 0)* |

TABLE 2
Results of the AD test against mold and algae in
exterior emulsion paint based on STA (Paint No. 2)

| | Mold | | Algae | |
|---|---|---|---|---|
| Finish | OB | 24 h washing | OB | 24 h washing |
| Unpreserved (0.00) | 4 | 4 | 4 | 4 |
| 0.50 | 1 | 3 | 1 | 1 |
| 0.75 | 1^{#} | 1 | 0)* | 1 |
| 1.00 | 0 | 1 | 0)* | 1 |
| 1.25 | 0 (0-20) | 1^{#} | 0)* | 1 |
| 1.50 | 0)* | 0 (0-20) | 0)* | 0)* |

1. A biocidal agent comprising biocidally active ingredients, wherein the active ingredients comprise;
A) at least one algicide selected from the group of the triazine algicides, urea algicides and uracil algicides;
B) propiconazole; and
C) at least one iodopropargyl compound.

2. The biocidal agent as claimed in claim 1, wherein at least one of the active ingredients is bound, preferably microencapsulated.

3. The biocidal agent as claimed in claim 1, wherein the at least one algicide is selected from the group consisting of terbutryn, cybutryn, propazin, terbuton, diuron, benzthiazuron, methabenzthiazuron, tebuthiuron, isoproturon and terbacil.

4. The biocidal agent as claimed in claim 1, wherein the algicide is diuron.

5. The biocidal agent as claimed in claim 1, wherein the at least one iodopropargyl compound is selected from the group consisting of 3-iodo-2-propynyl propylcarbamate, 3-iodo-2-propynyl butylcarbamate (IPBC), 3-iodo-2-propynyl m-chlorophenylcarbamate, 3-iodo-2-propynyl phenylcarbamate, 3-iodo-2-propynyl 2,4,5-trichlorophenyl ether, 3-iodo-2-propynyl-4-chlorophenylformal (IPCF), di(3-iodo-2-propynyl)hexyl dicarbamate, 3-iodo-2-propynyloxyethanol ethylcarbamate, 3-iodo-2-propynyloxyethanol phenylcarbamate, 3-iodo-2-propynyl thioxothioethylcarbamate, 3-iodo-2-propynylcarbamic acid ester (IPC), N-iodopropargyloxycarbonylalanine, N-iodopropargyloxycarbonylalanine ethyl ester, 3-(3-iodopropargyl)benzoxazol-2-one, 3-(3-iodopropargyl)-6-chlorobenzoxazol-2-one, 3-iodo-2-propynyl alcohol, 4-chlorphenyl-3-iodopropargyformal, 3-bromo-2,3-diiodo-2-propenyl ethylcarbamate, 3-iodo-2-propynyl n-hexylcarbamate, and 3-iodo-2-propynyl cyclohexylcarbamate.

6. The biocidal agent as claimed in claim 1, wherein the at least one iodopropargyl compound is 3-iodo-2-propynyl butylcarbamate.

7. The biocidal agent as claimed in claim 1, wherein the weight ratio of propiconazole to the sum of iodopropargyl compound(s) is 1:100 to 100:1, preferably 1:20 to 20:1 and particularly preferably 1:9 to 9:1.

8. The biocidal agent as claimed in claim 1, wherein the weight ratio of algicide(s) to the sum of propiconazole and the sum of iodopropargyl compound(s) Is 1:100 to 100:1, preferably 1:20 to 20:1 and particularly preferably 1:9 to 9:1.

9. The biocidal agent as claimed in claim 1, wherein the agent comprises 0.5 to 80% by weight, preferably 1 to 70% by weight, in particular 1 to 60% by weight of the active ingredients.

10. The biocidal agent as claimed in claim 2, at least one of the active ingredients is microencapsulated in microcapsules.

11. The biocidal agent as claimed in claim 10, wherein the microcapsules have a volume-averaged particle size of 0.3 to 100 μm.

12. The biocidal agent as claimed in claim 10, wherein the microcapsules comprise a melamine formaldehyde polymer as encapsulation material.

13. (canceled)

14. A method of protecting technical materials against attack and/or destruction by microorganisms, the method comprising incorporating biocidal agents as claimed in claim 1 into or onto the technical material to act on the microorganisms or their habitat.

15. A technical material obtained by treating a technical material with a biocidal agent as claimed in claim 1.

16. The technical material as claimed in claim 15, wherein the technical material is selected from adhesives, sizes, paper, cardboard, leather, wood, woodbase materials, wood/plastic composites, paints, coating compositions, plasters, cooling lubricants and heat transfer liquids.

17. The biocidal agent as claimed in claim 1, wherein:
the at least one algicide is selected from the group consisting of terbutryn, cybutryn, propazin, terbuton, diuron, benzthiazuron, methabenzthiazuron, tebuthiuron, isoproturon and terbacil;
the iodopropargyl compounds are selected from the group consisting of 3-iodo-2-propynyl propylcarbamate, 3-iodo-2-propynyl butylcarbamate (IPBC), 3-iodo-2-propynyl m-chlorophenylcarbamate, 3-iodo-2-propynyl phenylcarbamate, 3-iodo-2-propynyl 2,4,5-trichlorophenyl ether, 3-iodo-2-propynyl-4-chlorophenylformal (IPCF), di(3-iodo-2-propynyl)hexyl dicarbamate, 3-iodo-2-propynyloxyethanol ethylcarbamate, 3-iodo-2-propynyloxyethanol phenylcarbamate, 3-iodo-2-propynyl thioxothioethylcarbamate, 3-iodo-2-propynylcarbamic acid ester (IPC), N-iodopropargyloxycarbonylalanine, N-iodopropargyloxycarbonylalanine ethyl ester, 3-(3-iodopropargyl)benzoxazol-2-one, 3-(3-iodopropargyl)-6-chlorobenzoxazol-2-one, 3-iodo-2-propynyl alcohol, 4-chlorophenyl-3-iodopropargylformal, 3-bromo-2,3-diiodo-2-propenyl ethylcarbamate, 3-iodo-2-propynyl n-hexylcarbamate, and 3-iodo-2-propynyl cyclohexylcarbamate;
the weight ratio of algicide(s) to the sum of propiconazole and the sum of iodopropargyl compound(s) is 1:100 to 100:1;
the weight ratio of algicide(s) to the sum of propiconazole and the sum of iodopropargyl compound(s) is 1:100 to 100:1;
the agent comprises 0.5 to 80% by weight, preferably 1 to 70% by weight, in particular 1 to 60% by weight of active ingredients of the components A), B) and C); and
at least one of the active ingredients is microencapsulated in microcapsules.

18. The biocidal agent as claimed in claim 17, wherein:
the agent comprises 1 to 60% by weight of active ingredients A), B) and C);
the weight ratio of propiconazole to the sum of iodopropargyl compound(s) is 1:20 to 20:1;
the weight ratio of algicide(s) to the sum of propiconazole and the sum of iodopropargyl compound(s) is 1:20 to 20:1; and
the at least one algaecide is the active ingredient microencapsulated in the capsules.

19. The biocidal agent as claimed in claim 18, wherein:
the at least one algicide is diuron;
the iodopropargyl compound is 3-iodo-2-propynyl butylcarbamate;
the weight ratio of propiconazole to 3-iodo-2-propynyl butylcarbamate is 1:9 to 9:1;
the weight ratio of diuron to the sum of weights of propiconazole and 3-iodo-2-propynyl butylcarbamate is 1:9 to 9:1;
the microcapsules have a volume-averaged particle size of 0.3 to 100 μm; and
the microcapsules comprise a melamine formaldehyde polymer as encapsulation material.
